(19) United States
(12) Patent Application Publication
(10) Pub. No.: US 2007/0062045 A1
(43) Pub. Date: Mar. 22, 2007

(54) PORTIONING SPOONS

(76) Inventor: Patricia Ann Sylvie, Shreveport, LA (US)

Correspondence Address: NEIL J. COIG, 2355 DRUSILLA LANE, BATON ROUGE, LA, 70809, US

(21) Appl. No.: 11/533,361

(22) Filed: Sep. 19, 2006

Related U.S. Application Data
(60) Provisional application No. 60/596,382, filed on Sep. 20, 2005.

(51) Int. Cl. A47J 43/28

(52) U.S. Cl. 30/142; 30/324

(57) ABSTRACT

The present invention is a revised utensil is disclosed that is able to simultaneously portion and cook or serve food in desired quantities.

### CONTINUATION HISTORY

This application is a continuation of Provisional U.S. Patent Application 60/596,382, filed on Sep. 20, 2005, which is hereby incorporated by reference in its entirety.

### BACKGROUND OF THE INVENTION

The present invention relates to an improved design and implementation of portioning utensils, namely spoons, but can be any similar type of utensil.

In the traditional mode of portioning while cooking or serving, serving and or cooking cannot be done with the same set of utensils as those one might portion food with. This is due largely to the fact that cooking utensils and serving utensils are not graduated or otherwise marked to provide portioning information, such as liquid measure or dry weight.

Obvious downsides to the current state of the art exist. Persons having restricted diets, limited caloric intake or who wish to better monitor their consumption have no solution for spoons which both serve the purpose of serving and or cooking while simultaneously being able to portion food and/or liquid.

The consequence of these issues is the necessity to use multiple utensil sets, such as one set of utensils for cooking, one for serving and one or more for measuring while cooking, and yet another for measuring while serving. This becomes very time consuming, not only from the aspect of having to constantly switch utensil sets, but also from having to clean multiple sets of utensils.

The present invention of a unified transaction is thus a much-improved apparatus for combining the functions of cooking and serving utensils into a single tool. Clearly then, the present invention offers a much more complete and efficient solution that has yet to be addressed.

All of these aspects of the current mode of portioning food with multiple utensil sets lead to an increased need for a revised tool for measuring and cooking/serving, all of which the present invention addresses.

### OBJECTS OF THE INVENTION

One object of the invention is to provide a revised utensil for portioning.

Another object of this invention is to provide a revised utensil for cooking.

Yet another object of this invention is to provide a revised utensil for serving.

Still another object of this invention is to provide a revised utensil for combining cooking and portioning.

Still another object of this invention is to provide a revised utensil for combining serving and portioning.

Other objects and advantages of this invention shall become apparent from the ensuing descriptions of the invention.

### SUMMARY OF THE INVENTION

According to the present invention, a revised utensil is disclosed that is able to simultaneously portion and cook or serve food in desired quantities.

### BRIEF DESCRIPTION OF THE DRAWINGS

The accompanying drawings illustrate an embodiment of this invention. However, it is to be understood that this embodiment is intended to be neither exhaustive, nor limiting of the invention. They are but examples of some of the forms in which the invention may be practiced.

FIG. 1 is a perspective view of the measuring and cooking utensil.

FIG. 2 is a perspective view of the measuring and serving utensil.

### DETAILED DESCRIPTION OF EXEMPLARY EMBODIMENTS

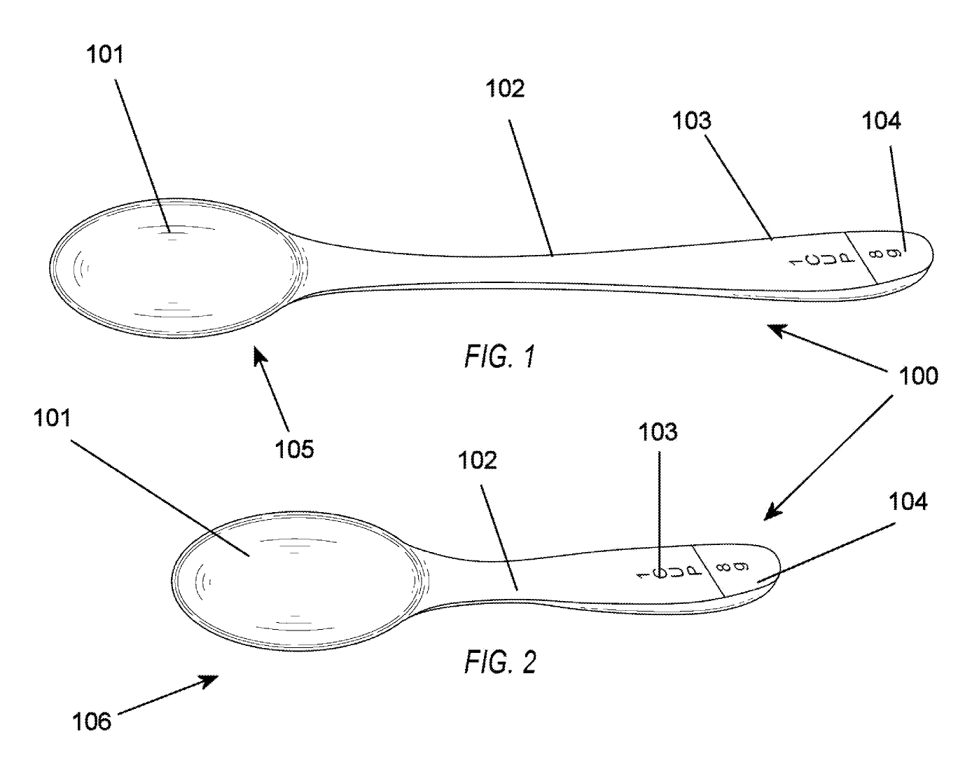

Without any intent to limit the scope of this invention, reference is made to the figures in describing the various embodiments of the invention. FIGS. 1-2 show various aspects of exemplary embodiments of the present invention.

The present invention relates to a series of utensils, particularly, in the preferred embodiment, spoons 100, which are specially designed portioning spoons that can be used by a variety of persons to help control their intake and to portion items, and which have elongated handles 102 attached to a bowl 101 which is used to portion and transport food and/or liquid from one location to another.

These specialized utensils include:
Long-handled cooking spoons 105 (handles ideally around 11 inches, but may be shorter or longer, depending on need)
Serving spoons 106 (handles ideally around 7-7½ inches, but may be shorter or longer depending on need)
Long-handled pot spoons 105 (handles ideally around 11 inches, but may be shorter or longer, depending on need)
Other spoons which may be used in cooking and/or serving

All of the above-described utensils would also employ a portioning capability, making the utensils dual-purpose. An indicator 103/104 such as engraved markings may be inscribed on the handle to show the portions delivered by the spoons. This indicator 103/104 may be shown in both English 103 and Metric 104 systems. Alternately or in conjunction, the spoons may have graduations on the bowl of the spoon to show the quantity of food or liquid delivered in the spoon.

In operation, then, these spoons are designed to help a person desiring to control the intake of food (such as those on a medical diet or watching their weight) by being able to quickly and easily portion the food items without the hassle and complication of measuring cups, scales or other portioning methods.

The current method of portioning food involves:
cooking food with one set of spoons,
transferring the food to another container,
obtaining measuring cups;
obtaining a scale;
filling a container with food with yet another set of utensils;
placing such container on a scale or portioning food into same;
adjust the portion according to the desired dietary intake; and
placing the portion on a plate.

As can be easily seen, this is drawn out, complicated, and renders several dishes dirty, promotes additional contamination of food, makes the food colder, and is generally cumbersome. However, it is also unnecessary in light of the present invention, since cooking and serving may be done easily with the present invention's portioning food set. The spoons can be in a variety of sizes, such as ¼ cup, ½ cup, ¾ cup, and 1 cup. Dual measurements can be printed on the spoon handle for easy reference, such as cups and ounces, or even metric measurement, both dry and liquid to aid in the versatility of the usage.

Other benefits include being able to recognize portions easily for times you eat out at restaurants or others' homes, so that approximations can be made on portions. Diabetics can easily serve themselves the correct portions. Suggested daily intake (such as the USRDA) can be portioned easily and without fuss. Another use is to teach children from a young age to portion food easily and without mess so that they may begin learning proper portioning at a young age to prevent problems later in life cause by eating improper quantities, such as diabetes, obesity and malnutrition.

Though simple in execution, the design is believed novel and innovative, and no prior art is known at this time, since no known art employs the portioning ability with a handle of sufficient length to comfortably reach into pots, bowls and other places where smaller portioning tools cannot be used.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims.

The invention claimed is:

1. A portioning utensil comprising an elongated handle of predetermined length having first and second opposite ends, and having operatively affixed to said first opposite end a bowl of predetermined volume, and on said second opposite end having an indicator, wherein said indicator's data corresponds to said volume of said bowl.

2. A portioning utensil according to claim 1 wherein said bowl further comprises markings on said bowl to correspond to said volume of said bowl.

3. A portioning utensil comprising an elongated handle of predetermined length having first and second opposite ends, and having operatively affixed to said first opposite end a bowl of predetermined volume, and on said second opposite end having an indicator, wherein said indicator's data corresponds to said volume of said bowl and is indicated in English and Metric units.

4. A portioning utensil according to claim 3 wherein said bowl further comprises markings on said bowl to correspond to said volume of said bowl.

5. A portioning utensil comprising an elongated handle of at least seven inches in length to permit the usage in deep bowls and pots and having first and second opposite ends, and having operatively affixed to said first opposite end a bowl of predetermined volume, and on said second opposite end having an indicator, wherein said indicator's data corresponds to said volume of said bowl.

6. A portioning utensil according to claim 5 wherein said bowl further comprises markings on said bowl to correspond to said volume of said bowl.
